(19) United States
(12) Patent Application Publication
(10) Pub. No.: US 2011/0237467 A1
(43) Pub. Date: Sep. 29, 2011

(54) NANOPARTICLE-DENSIFIED COMPLETION FLUIDS

(75) Inventors: H. Mitchell Cornette, Houston, TX (US); Craig Gardner, Houston, TX (US); Ben Bloys, Katy, TX (US); Earl Coludrovich, Missouri City, TX (US); Thomas G. Corbett, Willis, TX (US); Henry Bergeron, Houston, TX (US)

(73) Assignee: Chevron U.S.A. Inc., San Ramon, CA (US)

(21) Appl. No.: 12/731,938

(22) Filed: Mar. 25, 2010

(51) Int. Cl. C09K 8/68

(52) U.S. Cl. 507/219; 507/200; 507/203; 507/269; 507/270; 977/902

(57) ABSTRACT

The present invention is directed to completion fluid compositions and methods of making same. Such completion fluids are unique in that they utilize nanoparticles as weighting (densification) agents that increase the specific gravity (or density) of the fluid into which they are dispersed. Depending on their properties, such nanoparticulate weighting agents can vastly broaden the types of base fluid used in the completion fluid, permitting the use of non-aqueous and even hydrocarbon base fluids. Additionally, such nanoparticle-densified completion fluids can provide reduced environmental risks, and the nanoparticle weighting agents used therein can be more easily recovered from the based fluids into which they are dispersed.

### FIELD OF THE INVENTION

This invention relates generally to oilfield drilling and well completions, and specifically to compositions, methods, and systems for optimizing—through nanoparticle densification—the specific gravity of completion fluids.

### BACKGROUND

Well completion fluids are fluids used in completion operations associated with subterranean wells; such operations generally being those performed after drilling operations have ceased, but immediately before well production begins. The raison d'étre of these completion fluids is to provide a measure of protective control to a subterranean well in the event that the associated downhole hardware fails. Such fluids thereby contribute to a system that is protective of the formation and various completion elements within the well.

In their protective role, completion fluids improve the productivity of the well (e.g., an oil or gas well) by mitigating damage to the well structure in the production zone. Additionally, completion fluids assist in the process of repairing and cleaning out the well bore during the final completion phase.

Completion fluids are generally brines or mixtures of brines (i.e., aqueous-based solutions of metal chlorides, bromides, formates or mixtures thereof), wherein the metal salt component of the brine increases the specific gravity or density of the completion fluid relative to water. Regardless of the composition of the fluid, it should be chemically compatible with the reservoir formation of the well, as well as being compatible with the components used downhole. Completion fluids are usually subjected to stringent filtering, before being introduced into the well, so as to preclude the introduction of solids. For more background on completion fluids, see, e.g., Block, U.S. Pat. No. 4,541,485, issued Sep. 17, 1985; Shell, U.S. Pat. No. 4,502,969, issued Mar. 5, 1985; and Walker et al., U.S. Pat. No. 4,444,668, issued Apr. 24, 1984.

Use of metal salts as weighting agents in completion fluids all but dictates that the base fluid (of the completion fluid composition) is water. Additionally, environmental concerns may restrict the types of metal salts employed as weighting agents. In view of such limitations, a more flexible, and perhaps more environmentally-benign, completion fluid platform is clearly warranted.

BRIEF DESCRIPTION OF THE INVENTION

The present invention is directed to completion fluid compositions and methods of making same. Such completion fluids are unique in that they comprise nanoparticles, and that such nanoparticles are employed as weighting agents and relied upon to increase the specific gravity (or density) of the fluid. Indeed, migration to nanoparticulate weighting agents effects a paradigm shift in completion fluids technology. Depending on their properties, such nanoparticulate weighting agents can vastly broaden the types of base fluid used in the completion fluid—permitting the use of non-aqueous and even hydrocarbon base fluids. It is further contemplated that such nanoparticle-densified completion fluids will provide reduced environmental risks, and that the nanoparticle weighting agents used therein can be more easily recovered from the based fluids into which they are dispersed.

In some embodiments, the present invention is directed to one or more completion fluid compositions operable for use in well completion operations involving a subterranean well, wherein said composition(s) comprise(s): (a) a base fluid; and (b) a plurality of nanoparticles, wherein the nanoparticles: (i) are compatible with the base fluid; (ii) are generally compatible with the well completion operations; (iii) possess a mean diameter in the range of from about 1 nm to about 100 nm in at least two dimensions; (iv) are dispersible or otherwise suspendable in the base fluid; and (v) are operable for densifying the resulting completion fluid composition; wherein the resulting weight of said composition is a function of the size of the nanoparticles, the quantity of nanoparticles, and the specific gravity of the nanoparticles. In some such embodiments, the completion fluid composition further comprises a quantity of least one additive type selected from the group consisting of (i′) corrosion inhibitors, (ii′) O₂ scavengers, (iii′) bactericides, (iv′) pH modifiers, (v′) viscosifiers, (vi′) salts, (vii′) surfactants, (viii′) dispersal agents, and (ix′) de-foaming agents

In some embodiments, the present invention is directed to one or more methods of preparing a completion fluid usable in conjunction with well completion operations associated with subterranean wells, said method comprising the steps of: (a) selecting a quantity of nanoparticles on the basis of their specific gravity and inertness in relation to corresponding requirements for a particular application; and (b) adding the quantity of nanoparticles to a quantity of base fluid so as to provide for a nanoparticulate-weighted completion fluid, wherein the nanoparticles: are (i) compatible with the base fluid and the at least one additive type; (ii) generally compatible with the well completion operations; (iii) possess a mean diameter in the range of from about 1 nm to about 100 nm in at least two dimensions; (iv) are dispersible or otherwise suspendable in the base fluid; and (v) are operable for densifying the resulting completion fluid composition; and wherein the resulting weight of said composition is a function of the size of the nanoparticles, the quantity of nanoparticles, and the specific gravity of the nanoparticles. In some such embodiments, the methods further comprise a step of incorporating, in the resulting nanoparticulate-weighted completion fluid, a quantity of at least one additive type selected from the group consisting of (i′) corrosion inhibitors, (ii′) O₂ scavengers, (iii′) bactericides, (iv′) pH modifiers, (v′) viscosifiers, (vi′) salts, (vii′) surfactants, (viii′) dispersal agents, and (ix′) de-foaming agents.

The foregoing has outlined rather broadly the features of the present invention in order that the detailed description of the invention that follows may be better understood. Additional features and advantages of the invention will be described hereinafter which form the subject of the claims of the invention.

### DETAILED DESCRIPTION OF THE INVENTION

### 1. Introduction

As mentioned in the foregoing section, the present invention is directed to completion fluid compositions and methods by which they are manufactured or otherwise fabricated. Such completion fluids are unique in that they comprise nanoparticles that are colloidally-suspended in the fluid, and that such nanoparticles are relied upon to increase the specific gravity (or density) of the fluid.

The use of nanoparticulate weighting agents in completion fluid compositions provides considerable advantage over the existing art (note that the terms “weighting” and “densification” are used interchangeably herein). Depending on their properties, such nanoparticulate weighting agents can vastly broaden the types of base fluid used in the completion fluid, permitting the use of non-aqueous and even hydrocarbon base fluids. It is further contemplated that such nanoparticle-densified completion fluids will provide reduced environmental risks, and the nanoparticle weighting agents used therein can be more easily recovered from the based fluids into which they are dispersed.

### 2. Definitions

Certain terms are defined throughout this description as they are first used, while certain other terms used in this description are defined below:

The term “completion fluid,” as defined herein, refers to fluids used during well completion operations such as, but not limited to, pay zone drilling and/or underreaming, perforating, gravel packing, chemical treatments, hydraulic fracturing, cleanout, well killing, zone selective operations, and tubing and hardware replacement. For the purposes herein, such “completion fluids” are inclusive of “packer fluids.”

The term “nanoscale,” as defined herein, refers to dimensional attributes of 100 nm (10⁻⁹ m) or less.

A “nanoparticle,” as defined herein, is a three-dimensional object of a non-micellular nature, wherein at least two of said dimensions are nanoscale, but which no dimension is greater than 2 μm (microns). The terms “nanoparticle”—and “nanoparticulate” will be used interchangeably herein.

### 3. Compositions

In some embodiments, the present invention is directed to completion fluid compositions comprising nanoparticulates, wherein the nanoparticulates are dispersed within a base fluid so as to form an operationally-stable colloidal suspension, and wherein the nanoparticulates are small enough to pass through the filters normally used to remove particulates from completion fluids. Additionally, such nanoparticles are typically selected so as to be operationally-benign to the formation and the completion operations generally. The term “operational” is meant to imply that a particular attribute is valid within the operational parameters of the overall process in which some aspect is being described.

As mentioned above, in some embodiments the present invention is directed to at least one completion fluid composition operable for use in well completion operations involving a subterranean well, wherein said composition comprises: (a) a base fluid; and (b) a plurality of nanoparticles, wherein the nanoparticles: (i) are compatible with the base fluid; (ii) are generally compatible with the well completion operations; (iii) possess a mean diameter in the range of from about 1 nm to about 100 nm in at least two dimensions; (iv) are dispersible or otherwise suspendable in the base fluid; and (v) are operable for densifying the resulting completion fluid composition; wherein the resulting weight of said composition is a function of the size of the nanoparticles, the quantity of nanoparticles, and the specific gravity of the nanoparticles.

In some such above-described compositional embodiments, the completion fluid composition further comprises a quantity of least one additive type selected from the group consisting of (i′) corrosion inhibitors, (ii′) O₂ scavengers, (iii′) bactericides, (iv′) pH modifiers, (v′) viscosifiers, (vi′) salts, (vii′) surfactants, (viii′) dispersal agents, and (ix′) de-foaming agents. Such additives can be of any in current, prior, or contemplated use.

In some such above-described compositional embodiments, the nanoparticles are selected from the group consisting of metals, alloys, polymers, ceramics, mixed-matrix compositions, nanospheres, nanotubes, nanorods, nanoshells, and coated and non-coated combinations thereof. Possible nanoparticle compositions include, but are not limited to, iron oxide (Fe₂O₃), cerium oxide (CeO₂), lanthanum oxide (La₂O₃), aluminum oxide (Al₂O₃), titania (TiO₂), barium sulfate (BaSO₄), silica (SiO₂), aluminosilicates, clays (e.g., montmorillonite), combinations thereof, and the like. Note that the manufacture of such nanoparticles is not particularly limited, and that a wide variety of nanoparticles are commercially-available and manufactured with a variety of techniques.

In some such above-described compositional embodiments, the nanoparticles may possess unique physical and/or chemical properties by virtue of their nanoscale dimensions. Quantum confinement, for example, can result when a particle's dimensions drop below their Bohr exciton radius.

In some such above-described compositional embodiments, at least some of the nanoparticles are chemically-functionalized. In some such embodiments, this chemical functionalization is provided by chemically-modifying at least some of the nanoparticles with functional moieties on their surface. For examples of nanoparticle chemical-functionalization, see Mahalingam et al., “Directed Self-Assembly of Functionalized Silica Nanoparticles on Molecular Printboards through Multivalent Supramolecular Interactions,” Langmuir, vol. 20(26), pp. 11756-11762, 2004; and McNamara et al., “Acetylacetonate Anchors for Robust Functionalization of TiO₂ Nanoparticles with Mn(II)—Terpyridine Complexes,” vol. 130, pp. 14329-14338, 2008. Note that chemical functionalization can be used to improve nanoparticle dispersibility and/or suspendability, render nanoparticles chemically-inert, and to modify the nanoparticles' physical and/or chemical properties.

In some such above-described compositional embodiments, said composition is viscosifible. In some such embodiments, the composition is viscosified with a viscosifying agent. In other such embodiments, chemical modification of the nanoparticles (vide supra) can impart increased viscosity. In still other such embodiments, a combination of viscosifying agents and chemical modification of the nanoparticles is employed for this purpose. Examples of viscosifying agents, compositions, and systems are described in Vollmer et al., U.S. Pat. No. 5,785,747, issued Jul. 28, 1998.

In some such above-described compositional embodiments, said composition is crosslinkable. Examples of crosslinkable completion fluid compositions can be found in, e.g., Chang et al., U.S. Pat. No. 6,342,467, issued Jan. 29, 2002.

Notwithstanding the viscosifiable and crosslinkable attributes mentioned above, in some such above-described compositional embodiments, said composition embodies, otherwise comprises, or is used in combination with, a fluid-loss pill. See, e.g., Vollmer et al., U.S. Pat. No. 6,632,779, issued Oct. 14, 2003.

In some such above-described compositional embodiments, said composition is filterable. By this it is meant that the subject (nanoparticle-densified) completion fluid can be filtered to remove larger particles (typically >2 μm or microns) that might have deleterious effects on one or more completion operations, but wherein such filtration preserves the presence of nanoparticles in the composition. If desired, such nanoparticles can be removed by additional procedures including, but not limited to, nanofiltration and centrifugation. For more on the filtration of such larger particles see, e.g., Bergh, U.S. Pat. No. 4,664,798, issued May 12, 1987.

In some such above-described compositional embodiments, the base fluid is aqueous-based. Examples of such aqueous-based base fluids include various brines, as well as substantially pure water. Where brines are utilized, the salts native to the brine(s) can effectively act as weighting agents (in addition to the nanoparticles) in the completion fluid composition.

The use of metal salts as weighting or densification agents typically requires that they be dissolved in a polar base fluid (e.g., water). Nanoparticle densification agents (i.e., the nanoparticles) can be engineered to have surface energies amenable to suspension in a variety of base fluids. Accordingly, in some such above-described compositional embodiments, the base fluid is hydrocarbon-based. In some such embodiments, the engineering of such compatible surface energies is afforded by chemical modification of the nanoparticle surface (vide supra).

Via the use of nanoparticles (and optionally metal salts), in some such above-described compositional embodiments, the composition is weighted (densified) to at least about 7.5 pounds per gallon (ppg), and at most about 22 ppg. In some such embodiments, the composition is weighted to at least 9 ppg, in some embodiments to at least 10 ppg, in some embodiments to at least 11 ppg, and in some embodiments to at least 12 ppg.

In some such above-described compositional embodiments, said completion fluid composition further comprises a dispersal agent operable for dispersing the nanoparticles in the base fluid. In some such embodiments, the dispersal agent is a surfactant selected from the group consisting of ionic surfactants (e.g., sodium dodecyl sulfate and cetyl trimethylammonium bromide), non-ionic surfactants (e.g., Triton X-100®), Pluronics®), and combinations thereof. Such dispersal agents may also serve to keep the nanoparticles suspended in the fluid, e.g., as a stable suspension. For examples of how surfactants can be used to assist in the dispersal of nanoparticles, see Li et al., “Emergent Nanostructures: Water-Induced Mesoscale Transformation of Surfactant-Stabilized Amorphous Calcium Carbonate Nanoparticles in Reverse Microemulsions,” Advanced Functional Materials, vol. 12 (11-12), pp. 773-779, 2002.

In some such above-described compositional embodiments, nanoparticles comprise at least about 0.1 wt. % of the composition and at most about 60 wt. % of the composition. In some or other embodiments, nanoparticles comprise at least about 0.1 wt. % of the composition and at most about 40 wt. % of the composition. In some or still other embodiments, nanoparticles comprise at least about 0.5 wt. % of the composition and at most about 30 wt. % of the composition.

In addition to the selection criteria described (or otherwise inferred) above, selection of suitable nanoparticles may also be influenced by economic considerations. Safety (e.g., toxicity) and environmental factors can also play a significant role in the selection of nanoparticles for the above-described compositional embodiments.

### 4. Methods

Generally, methods of the present invention are directed to the use of the above-described completion fluid compositions in well completion operations, and to methods of making such compositions.

In some embodiments, the present invention is directed to one or more methods for preparing a completion fluid usable in conjunction with well completion operations associated with subterranean wells (e.g., oil and/or gas wells), said method(s) comprising the steps of: (a) selecting a quantity of nanoparticles on the basis of their specific gravity and inertness in relation to corresponding requirements for a particular application; and (b) adding the quantity of nanoparticles to a quantity of base fluid so as to provide for a nanoparticulate-weighted completion fluid, wherein the nanoparticles: are (i) compatible with the base fluid and the at least one additive type; (ii) generally compatible with the well completion operations; (iii) possess a mean diameter in the range of from about 1 nm to about 100 nm in at least two dimensions; (iv) are dispersible or otherwise suspendable in the base fluid; and (v) are operable for densifying the resulting completion fluid composition; and wherein the resulting weight of said composition is a function of the size of the nanoparticles, the quantity of nanoparticles, and the specific gravity of the nanoparticles.

In some such above-described method embodiments, such methods further comprising a step of incorporating, in the resulting nanoparticulate-weighted completion fluid, a quantity of at least one additive type selected from the group consisting of (i′) corrosion inhibitors, (ii′) O₂ scavengers, (iii′) bactericides, (iv′) pH modifiers, (v′) viscosifiers, (vi′) salts, (vii′) surfactants, (viii′) dispersal agents, and (ix′) de-foaming agents.

In some such above-described method embodiments, the base fluid is selected from the group consisting of aqueous-based base fluids, hydrocarbon-based base fluids, and combinations thereof. As described above, the use of nanoparticles as weighting agents facilitates the use of non-aqueous (e.g., hydrocarbon) base fluids in formulating completion fluid compositions in accordance with some of the embodiments put forth herein.

In some such above-described method embodiments, the nanoparticulate-weighted completion fluid is densified to at least about 7.5 ppg and at most about 22 ppg. In some such above-described method embodiments, the (nanoparticle densified) completion fluid composition is densified (weighted) to 9 ppg or more. In some or other embodiments, the completion fluid composition is densified to 10 ppg or more. In some or other embodiments, the completion fluid composition is densified to 11 ppg or more. In some or still other embodiments, the completion fluid composition is densified to 12 ppg or more.

Depending on the desired density/weight of the completion fluid, nanoparticles can be added so as to comprise at least about 0.1 wt. % of the composition and at most about 60 wt. % of the composition of the completion fluid so made. In some or other embodiments, nanoparticles are added so as to comprise at least about 0.1 wt. % of the composition and at most about 40 wt. % of the composition. In some or still other embodiments, nanoparticles are added so as to comprise at least about 0.5 wt. % of the composition and at most about 30 wt. % of the composition.

In some such above-described method embodiments, said methods may further comprise a step of viscosifying the nanoparticulate-weighted completion fluid. See preceding section (Section 3, above) for additional description and reference with respect to viscosification and viscosification agents/viscosifiers.

In some such above-described method embodiments, such methods can further comprise a step of crosslinking the nanoparticulate-weighted completion fluid. See preceding section (Section 3, above) for additional description and reference with respect to crosslinking of the completion fluid so prepared.

In some such above-described method embodiments, such methods can further comprise a step of filtering the nanoparticulate-weighted completion fluid. As described above, the filtration is carried out to remove particulates having dimensions/diameters in excess of 2 μm (microns), but which allows the completion fluid to retain the nanoparticles—which are much smaller in at least two dimensions. In some such method embodiments, the step of filtering is accomplished using a filter of a type selected from the group consisting of diatomaceous earth filters, sock filters, metal mesh filters, weave filters, and combinations thereof.

In some such above-described method embodiments, at least some of the nanoparticles are chemically-modified with functional moieties on their surface. As mentioned above, such chemical modification of the nanoparticulate surface can serve to alter their surface energy and hence, their dispersability in a particular base fluid. Additionally, such chemical modification can participate in the crosslinking of the completion fluid (vide supra). See preceding section (Section 3, above) for additional description and reference with respect to chemical modification of the nanoparticles.

### 5. Summary

The present invention, as described in the preceding sections, is largely directed to completion fluid compositions and methods of their manufacture. Such completion fluids are unique by virtue of the fact that they comprise nanoparticles, and that these nanoparticles are employed as weighting (densification) agents and relied upon to increase the specific gravity (or density) of the completion fluid. The use of nanoparticules in this way represents a paradigm shift in completion fluids technology. Depending on the properties such nanoparticles can be engineered to possess, such nanoparticulate weighting agents can vastly broaden the types of base fluid used in the completion fluid, permitting the use of non-aqueous and even hydrocarbon base fluids. Such nanoparticle-densified completion fluids can also provide reduced environmental risks, and the nanoparticle weighting agents used therein can be more easily recovered from the based fluids into which they are dispersed.

All patents and publications referenced herein are hereby incorporated by reference to an extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed:

1. A completion fluid composition operable for use in well completion operations involving a subterranean well, wherein said composition comprises:
a) a base fluid; and
b) a plurality of nanoparticles, wherein the nanoparticles: (i) are compatible with the base fluid; (ii) are generally compatible with the well completion operations; (iii) possess a mean diameter in the range of from about 1 nm to about 100 nm in at least two dimensions; (iv) are dispersible or otherwise suspendable in the base fluid; and (v) are operable for densifying the resulting completion fluid composition; wherein the resulting weight of said composition is a function of the size of the nanoparticles, the quantity of nanoparticles, and the specific gravity of the nanoparticles.

2. The completion fluid composition of claim 1, further comprising a quantity of least one additive type selected from the group consisting of (i′) corrosion inhibitors, (ii′) O₂ scavengers, (iii′) bactericides, (iv′) pH modifiers, (v′) viscosifiers, (vi′) salts, (vii′) surfactants, (viii′) dispersal agents, and (ix′) de-foaming agents.

3. The completion fluid composition of claim 1, wherein said composition is viscosifible.

4. The completion fluid composition of claim 1, wherein said composition is crosslinkable.

5. The completion fluid composition of claim 1, wherein said composition is filterable.

6. The completion fluid composition of claim 1, wherein the base fluid is aqueous-based.

7. The completion fluid composition of claim 1, wherein the base fluid is hydrocarbon-based.

8. The completion fluid composition of claim 1, wherein the nanoparticles are selected from the group consisting of metals, alloys, polymers, ceramics, mixed-matrix compositions, nanospheres, nanotubes, nanorods, nanoshells, and coated and non-coated combinations thereof.

9. The completion fluid composition of claim 1, wherein at least some of the nanoparticles are chemically-modified with functional moieties on their surface.

10. The completion fluid composition of claim 9, wherein the functional moieties enhance nanoparticle suspendability in the completion fluid.

11. The composition of claim 1, wherein the composition is weighted to at least about 7.5 ppg and at most about 22 ppg.

12. A method for preparing a completion fluid usable in conjunction with well completion operations associated with subterranean wells, said method comprising the steps of:
a) selecting a quantity of nanoparticles on the basis of their specific gravity and inertness in relation to corresponding requirements for a particular application; and
b) adding the quantity of nanoparticles to a quantity of base fluid so as to provide for a nanoparticulate-weighted completion fluid,
wherein the nanoparticles: are (i) compatible with the base fluid and the at least one additive type; (ii) generally compatible with the well completion operations; (iii) possess a mean diameter in the range of from about 1 nm to about 100 nm in at least two dimensions; (iv) are dispersible or otherwise suspendable in the base fluid; and (v) are operable for densifying the resulting completion fluid composition; and wherein the resulting weight of said composition is a function of the size of the nanoparticles, the quantity of nanoparticles, and the specific gravity of the nanoparticles.

13. The method of claim 12, further comprising a step of incorporating, in the resulting nanoparticulate-weighted completion fluid, a quantity of at least one additive type selected from the group consisting of (i′) corrosion inhibitors, (ii′) O₂ scavengers, (iii′) bactericides, (iv′) pH modifiers, (v′) viscosifiers, (vi′) salts, (vii′) surfactants, (viii′) dispersal agents, and (ix′) de-foaming agents.

14. The method of claim 12, wherein the base fluid is selected from the group consisting of aqueous-based base fluids, hydrocarbon-based base fluids, and combinations thereof.

15. The method of claim 12, wherein the nanoparticulate-weighted completion fluid is densified to at least about 7.5 ppg and at most about 22 ppg.

16. The method of claim 15, further comprising a step of viscosifying the nanoparticulate-weighted completion fluid.

17. The method of claim 15, further comprising a step of crosslinking the nanoparticulate-weighted completion fluid.

18. The method of claim 15, further comprising a step of filtering the nanoparticulate-weighted completion fluid.

19. The method of claim 18, wherein the step of filtering is accomplished using a filter of a type selected from the group consisting of diatomaceous earth filters, sock filters, metal mesh filters, weave filters, and combinations thereof.

20. The method of claim 15, wherein at least some of the nanoparticles are chemically-modified with functional moieties on their surface.
